(19) United States
(12) Patent Application Publication
(10) Pub. No.: US 2025/0168291 A1
(43) Pub. Date: May 22, 2025

(54) EFFICIENT NEURAL NETWORK ENCODING FORD 3D COLOR LOOKUP TABLES

(71) Applicant: SAMSUNG ELECTRONICS CO., LTD., Suwon-si (KR)

(72) Inventors: Vahid ZEHTAB, Toronto (CA); Marcus Anthony BRUBAKER, Toronto (CA); Michael Scott brown, Toronto (DE); David Brian LINDELL, Toronto (CA)

(73) Assignee: SAMSUNG ELECTRONICS CO., LTD., Suwon-si (KR)

(21) Appl. No.: 18/798,324

(22) Filed: Aug. 8, 2024

Related U.S. Application Data
(60) Provisional application No. 63/601,921, filed on Nov. 22, 2023.

(51) Int. Cl. H04N 1/60

(52) U.S. Cl. CPC H04N 1/60

(57) ABSTRACT

The present disclosure provides methods, apparatuses, systems, and computer-readable mediums for encoding color lookup tables (LUTs) by an apparatus. A method includes determining a first identifier corresponding to a first LUT of a plurality of LUTs, providing, to a trained machine learning model, the first identifier and an input lattice, obtaining, from the trained machine learning model, an output lattice corresponding to the first LUT, and performing color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs.

### CROSS-REFERENCE TO RELATED APPLICATIONS

This application claims benefit of priority under 35 U.S.C. § 119 to U.S. Provisional Patent Application No. 63/601,921, filed on Nov. 22, 2023, in the U.S. Patent and Trademark Office, the disclosure of which is incorporated by reference herein in its entirety.

### BACKGROUND

### 1. Field

The present disclosure relates generally to image processing, and more particularly to methods, apparatuses, systems, and non-transitory computer-readable mediums for encoding color lookup tables.

### 2. Description of Related Art

Color manipulation may be considered a fundamental operation in computer vision and/or image processing applications, in which input color values (e.g., red-green-blue (RGB)) may be mapped (or encoded) to specific (and/or different) output color values. For example, a method for encoding such color manipulation may be performed through the use of a three-dimensional (3D) color lookup table (LUT). LUTs may be applied to a diverse range of applications, such as, but not limited to, video editing, in-camera processing, photographic filters, computer graphics, color processing for displays, or the like. Additionally, LUTs may be used to ensure color accuracy and/or consistency across various types of display devices (or hardware).

A single LUT may need a relatively manageable amount of memory storage. That is, the amount of memory (e.g., memory footprint) needed for storing a single LUT may not be excessively large. For example, a low resolution 33×33×33 LUT at a 16-bit precision may need about 85 kilobytes (KB) of memory storage. As another example, a high resolution 65×65×65 LUT at a 16-bit precision may need about 0.5 megabytes (MB) of memory storage. However, related color manipulation applications may utilize LUT libraries that may contain a relatively large quantity (e.g., hundreds) of LUTs.

Thus, there exists a need for further improvements to color manipulation applications, as the need for increasing quantities of LUTs may be constrained by memory storage requirements. Improvements are presented herein. These improvements may also be applicable to other image processing technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, systems, and non-transitory computer-readable mediums for encoding color lookup tables (LUTs) are disclosed by the present disclosure.

One or more example embodiments of the present disclosure provide for encoding a plurality of LUTs into a machine learning model that potentially reduces a memory resource footprint needed to store the plurality of LUTs when compared to related data compression technologies.

Further, one or more example embodiments of the present disclosure provide for encoding a plurality of LUTs into a machine learning model that provides combinations of LUTs and/or provides invertible approximations of LUTs.

According to an aspect of the present disclosure, a method for encoding LUTs includes determining a first identifier corresponding to a first LUT of a plurality of LUTs, providing, to a trained machine learning model, the first identifier and an input lattice, obtaining, from the trained machine learning model, an output lattice corresponding to the first LUT, and performing color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs.

In some embodiments, the input lattice may include a regularly spaced grid, the output lattice may include the first LUT, and the performing of the color manipulation on the at least one input image may include applying the first LUT, obtained from the trained machine learning model, to the at least one input image.

In some embodiments, the input lattice may include the at least one input image, the output lattice may include at least one color-manipulated image based on the first LUT, the at least one color-manipulated image may correspond to the at least one input image, and the performing of the color manipulation on the at least one input image may include providing the at least one color-manipulated image obtained from the trained machine learning model.

In some embodiments, the input lattice may include a Hald image at a first resolution level, and the output lattice may include the first LUT at the first resolution level.

In some embodiments, a first resolution level of the output lattice may match a second resolution level of the input lattice, and the first resolution level of the output lattice may be different from a third resolution level of the first LUT.

In some embodiments, the method may further include selecting a plurality of random input colors from an input color space based on a predetermined distribution, normalizing the plurality of random input colors to a predetermined range of values, computing a plurality of target colors by applying the normalized plurality of random input colors to a machine learning model, normalizing the plurality of target colors to the input color space, determining a reconstruction error based on the plurality of target colors, and adjusting weights of the machine learning model based on the reconstruction error to obtain the trained machine learning model.

In some embodiments, the predetermined distribution may include a uniform distribution of colors across the input color space.

In some embodiments, the method may further include determining occurrence probabilities of colors in the input color space, and determining the predetermined distribution based on the colors in the input color space having an occurrence probability that exceeds a predetermined threshold.

In some embodiments, the method may further include restricting the weights of the machine learning model through spectral normalization and activation functions, and the output lattice may include an invertible approximation of the first LUT.

In some embodiments, the method may further include providing, to the trained machine learning model, a second identifier and the input lattice, the second identifier indicating the first LUT and a second LUT of the plurality of LUTs, and obtaining, from the trained machine learning model, another output lattice corresponding to a combination of the first LUT and the second LUT.

According to an aspect of the present disclosure, an apparatus for encoding LUTs includes a memory storing instructions, and one or more processors communicatively coupled to the memory. The one or more processors are configured to execute the instructions to determine a first identifier corresponding to a first LUT of a plurality of LUTs, provide, to a trained machine learning model, the first identifier and an input lattice, obtain, from the trained machine learning model, an output lattice corresponding to the first LUT, and perform color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs.

In some embodiments, the input lattice may include a regularly spaced grid, the output lattice may include the first LUT, and the one or more processors may be further configured to execute further instructions to apply the first LUT, obtained from the trained machine learning model, to the at least one input image.

In some embodiments, the input lattice may include the at least one input image, the output lattice may include at least one color-manipulated image based on the first LUT, the at least one color-manipulated image may correspond to the at least one input image, and the one or more processors may be further configured to execute further instructions to perform the color manipulation on the at least one input image using the at least one color-manipulated image obtained from the trained machine learning model.

In some embodiments, the input lattice may include a Hald image at a first resolution level, and the output lattice may include the first LUT at the first resolution level.

In some embodiments, a first resolution level of the output lattice, may match a second resolution level of the input lattice, and the first resolution level of the output lattice may be different from a third resolution level of the first LUT.

In some embodiments, the one or more processors may be further configured to execute further instructions to select a plurality of random input colors from an input color space based on a predetermined distribution, normalize the plurality of random input colors to a predetermined range of values, compute a plurality of target colors by applying the normalized plurality of random input colors to a machine learning model, normalize the plurality of target colors to the input color space, determine a reconstruction error based on the plurality of target colors, and adjust weights of the machine learning model based on the reconstruction error to obtain the trained machine learning model. The predetermined distribution may include a uniform distribution of colors across the input color space.

In some embodiments, the one or more processors may be further configured to execute further instructions to determine occurrence probabilities of colors in the input color space, and determine the predetermined distribution based on the colors in the input color space having an occurrence probability that exceeds a predetermined threshold.

In some embodiments, the one or more processors may be further configured to execute further instructions to restrict the weights of the machine learning model through spectral normalization and activation functions. The output lattice may include an invertible approximation of the first LUT.

According to an aspect of the present disclosure, an apparatus for encoding LUTs includes means for determining a first identifier corresponding to a first LUT of a plurality of LUTs, means for providing, to a trained machine learning model, the first identifier and an input lattice, means for obtaining, from the trained machine learning model, an output lattice corresponding to the first LUT, and means for performing color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs.

According to an aspect of the present disclosure, a non-transitory computer-readable storage medium storing computer-executable instructions for encoding LUTs by an apparatus is provided. The computer-executable instructions, when executed by at least one processor of the apparatus, cause the apparatus to determine a first identifier corresponding to a first LUT of a plurality of LUTs, provide, to a trained machine learning model, the first identifier and an input lattice, obtain, from the trained machine learning model, an output lattice corresponding to the first LUT, and perform color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs,

In some embodiments, the computer-executable instructions, when executed by the at least one processor, may further cause the apparatus to select a plurality of random input colors from an input color space based on a predetermined distribution, normalize the plurality of random input colors to a predetermined range of values, compute a plurality of target colors by applying the normalized plurality of random input colors to a machine learning model, normalize the plurality of target colors to the input color space, determine a reconstruction error based on the plurality of target colors, and adjust weights of the machine learning model based on the reconstruction error to obtain the trained machine learning model.

Additional aspects are set forth in part in the description that follows and, in part, may be apparent from the description, or may be learned by practice of the presented embodiments of the disclosure.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates an example of a device that may be used in implementing one or more aspects of the present disclosure;

FIG. 2 depicts an example of a color manipulation operation, in accordance with various aspects of the present disclosure;

FIG. 3 illustrates an example of a color manipulation operation using Hald images, in accordance with various aspects of the present disclosure;

FIG. 4A depicts an example of a block diagram for encoding three-dimensional (3D) color lookup tables (LUTs), in accordance with various aspects of the present disclosure;

FIG. 4B illustrates an example architecture of a LUT encoding model, in accordance with various aspects of the present disclosure;

FIG. 4C depicts an example architecture of a residual component as shown in FIG. 4C, in accordance with various aspects of the present disclosure;

FIG. 4D illustrates a flowchart of an example method for training a LUT encoding model, in accordance with various aspects of the present disclosure;

FIGS. 5A and 5B depict example use cases of a LUT encoding model, in accordance with various aspects of the present disclosure;

FIG. 6 illustrates an example of bijective transformations using a comparative example and a LUT encoding model, in accordance with various aspects of the present disclosure;

FIG. 7 depicts an example of LUT blending, in accordance with various aspects of the present disclosure;

FIG. 8 illustrates a block diagram of an example apparatus for encoding LUTs, in accordance with various aspects of the present disclosure; and

FIG. 9 depicts a flowchart of an example method of encoding LUTs, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it is to be apparent to those skilled in the art that these concepts may be practiced without these specific details. In some instances, well known structures and components are shown in block diagram form in order to avoid obscuring such concepts. In the descriptions that follow, like parts are marked throughout the specification and drawings with the same numerals, respectively.

The following description provides examples, and is not limiting of the scope, applicability, or embodiments set forth in the claims. Changes may be made in the function and/or arrangement of elements discussed without departing from the scope of the present disclosure. Various examples may omit, substitute, or add various procedures or components as appropriate. For example, the methods described may be performed in an order different from that described, and various steps may be added, omitted, and/or combined. Alternatively or additionally, features described with reference to some examples may be combined in other examples.

Various aspects and/or features may be presented in terms of systems that may include a number of devices, components, modules, or the like. It is to be understood and appreciated that the various systems may include additional devices, components, modules, or the like and/or may not include all of the devices, components, modules, or the like discussed in connection with the figures. A combination of these approaches may also be used.

As a general introduction to the subject matter described in more detail below, aspects described herein are directed towards apparatuses, methods, systems, and non-transitory computer-readable mediums for encoding color lookup tables (CLUTs, or simply LUTs). Aspects described herein may be used to significantly reduce a memory resource footprint that may be needed to store and reconstruct a relatively large number of LUTs, when compared to related data compression technologies, while still providing an acceptable level of perceptual color distortion (e.g., average color difference). Further, aspects described herein may be used to generate combinations of LUTs and/or provide invertible approximations of LUTs.

Aspects presented herein may provide for a machine learning model that may be jointly trained with the plurality of LUTs and identification information for each of the LUTs and configured to provide an output lattice corresponding to a requested LUT. Advantageously, a memory resource footprint of the machine learning model may be significantly reduced when compared to a memory resource footprint needed for individually storing each of the plurality of LUTs, even when the LUTs are compressed using related data compression techniques. In addition, the machine learning model may combine (e.g., blend) two (2) or more LUTs to generate additional LUTs from the original plurality of LUTs. Furthermore, the machine learning model may be trained so as to produce invertible approximations of LUTs that may allow for inverting (or reversing) the color manipulation of a LUT.

Although the present disclosure describes a machine learning model trained and/or configured to perform color manipulation using three-dimensional (3D) color lookup tables (LUTs) based on a red-green-blue (RGB) color space, the present disclosure is not limited in this regard. For example, the concepts described herein may be applied to other color spaces, such as, but not limited to, luma-chroma (YCbCr), hue saturation value (HSV), International Commission on Illumination (CIE) 1931 RGB, CIE 1931 XYZ, or the like. As another example, the concepts described herein may be applied to LUTs that have more than three (3) dimensions (e.g., four (4) or more dimensions) without departing from the scope of the present disclosure.

Notably, the aspects presented herein may be applied to store and/or reconstruct a relatively large amount of LUTs with a significantly reduced memory resource footprint, when compared to related data compression techniques.

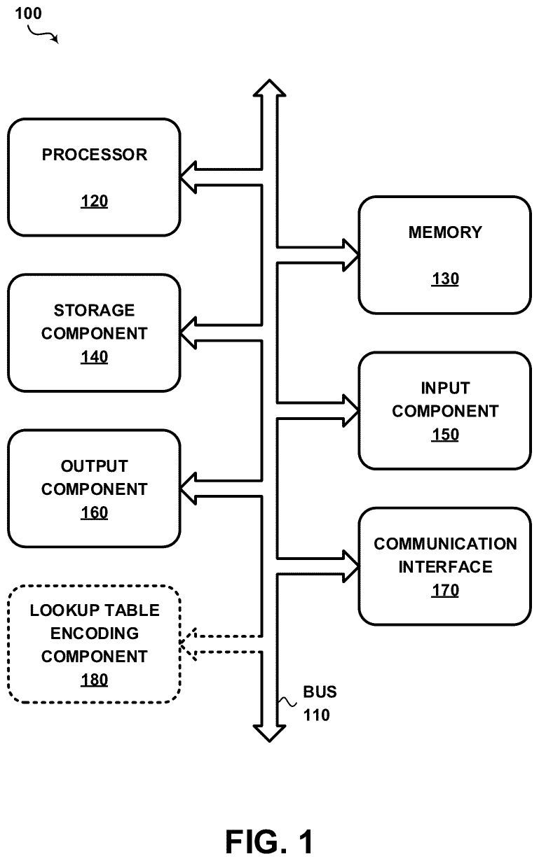

As noted above, certain embodiments are discussed herein that relate to encoding LUTs. Before discussing these concepts in further detail, however, an example of a computing device that may be used in implementing and/or otherwise providing various aspects of the present disclosure is discussed with respect to FIG. 1.

FIG. 1 depicts an example of a device 100 that may be used in implementing one or more aspects of the present disclosure in accordance with one or more illustrative aspects discussed herein. For example, device 100 may, in some instances, implement one or more aspects of the present disclosure by reading and/or executing instructions and performing one or more actions accordingly. In one or more arrangements, device 100 may represent, be incorporated into, and/or include a processor, a personal computer (PC), a printed circuit board (PCB) including a computing device, a minicomputer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device. Alternatively or additionally, the device 100 may represent, be incorporated into, and/or include a desktop computer, a computer server, a virtual machine, a network appliance, a mobile device (e.g., a user equipment (UE), a laptop computer, a tablet computer, a personal digital assistant (PDA), a smart phone, any other type of mobile computing device, or the like), a camera, a wearable device (e.g., smart watch, headset, headphones, or the like), a smart device (e.g., a voice-controlled virtual assistant, a set-top box (STB), a refrigerator, an air conditioner, a microwave, a television (TV), or the like), an Internet-of-Things (IoT) device, and/or any other type of data processing device.

For example, the device 100 may include a processor, a personal computer (PC), a printed circuit board (PCB) including a computing device, a mini-computer, a mainframe computer, a microcomputer, a telephonic computing device (e.g., a cellular phone, a smart phone, a session initiation protocol (SIP) phone, a wired/wireless computing device (e.g., a smartphone, a PDA), a laptop, a tablet, a smart device, a wearable device, or any other similar functioning device.

In some embodiments, as shown in FIG. 1, the device 100 may include a set of components, such as a processor 120, a memory 130, a storage component 140, an input component 150, an output component 160, a communication interface 170, and a lookup table (LUT) encoding component 180. The set of components of the device 100 may be communicatively coupled via a bus 110.

The bus 110 may include one or more components that may permit communication among the set of components of the device 100. For example, the bus 110 may be a communication bus, a cross-over bar, a network, or the like. Although the bus 110 is depicted as a single line in FIG. 1, the bus 110 may be implemented using multiple (e.g., two (2) or more) connections between the set of components of device 100. The present disclosure is not limited in this regard.

The device 100 may include one or more processors, such as the processor 120. The processor 120 may be implemented in hardware, firmware, and/or a combination of hardware and software. For example, the processor 120 may include a central processing unit (CPU), an application processor (AP), a graphics processing unit (GPU), an accelerated processing unit (APU), a microprocessor, a microcontroller, a digital signal processor (DSP), a field-programmable gate array (FPGA), an application-specific integrated circuit (ASIC), an image signal processor (ISP), a neural processing unit (NPU), a sensor hub processor, a communication processor (CP), an artificial intelligence (AI)-dedicated processor designed to have a hardware structure specified to process an AI model, a general purpose single-chip and/or multi-chip processor, or other programmable logic device, discrete gate or transistor logic, discrete hardware components, or any combination thereof designed to perform the functions described herein. A general purpose processor may include a microprocessor, or any conventional processor, controller, microcontroller, or state machine.

The processor 120 may also be implemented as a combination of computing devices, such as a combination of a DSP and a microprocessor, a combination of a main processor and an auxiliary processor, a plurality of microprocessors, one or more microprocessors in conjunction with a DSP core, or any other such configuration. In some embodiments, particular processes and methods may be performed by circuitry that is specific to a given function. In optional or additional embodiments, an auxiliary processor may be configured to consume less power than the main processor. Alternatively or additionally, the one or more processors may be implemented separately (e.g., as several distinct chips) and/or may be combined into a single form.

The processor 120 may control overall operation of the device 100 and/or of the set of components of device 100 (e.g., the memory 130, the storage component 140, the input component 150, the output component 160, the communication interface 170, and the LUT encoding component 180).

The device 100 may further include the memory 130. In some embodiments, the memory 130 may include volatile memory such as, but not limited to, random access memory (RAM), static RAM (SRAM), dynamic RAM (DRAM), or the like. In optional or additional embodiments, the memory 130 may include non-volatile memory such as, but not limited to, read only memory (ROM), electrically erasable programmable ROM (EEPROM), NAND flash memory, phase-change RAM (PRAM), magnetic RAM (MRAM), resistive RAM (RRAM), ferroelectric RAM (FRAM), magnetic memory, optical memory, or the like. However, the present disclosure is not limited in this regard, and the memory 130 may include other types of dynamic and/or static memory storage. In an embodiment, the memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further include the input component 150. The input component 150 may include one or more components that may permit the device 100 to receive information, such as via user input (e.g., a touch screen, a keyboard, a keypad, a mouse, a stylus, a button, a switch, a microphone, a camera, a virtual reality (VR) headset, haptic gloves, or the like). Alternatively or additionally, the input component 150 may include one or more sensors for sensing information (e.g., a global positioning system (GPS) component, an accelerometer, a gyroscope, an actuator, a transducer, a contact sensor, a proximity sensor, a ranging device, a camera, a video camera, a depth camera, a time-of-flight (TOF) camera, a stereoscopic camera, or the like). In an embodiment, the input component 150 may include more than one of a same sensor type (e.g., multiple cameras).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, a buzzer, an alarm, or the like).

The device 100 may further include the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, or the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as, FlashLinQ, WiMedia, Bluetooth™, Bluetooth™ Low Energy (BLE), ZigBee, Institute of Electrical and Electronics Engineers (IEEE) 802.11x (Wi-Fi), LTE, 5G, or the like. In optional or additional embodiments, the communication interface 170 may include an Ethernet interface, an optical interface, a coaxial interface, an infrared interface, a radio frequency (RF) interface, a USB interface, an IEEE 1094 (FireWire) interface, or the like.

In some embodiments, the device 100 may include the LUT encoding component 180, which may be configured to encode LUTs. For example, the LUT encoding component 180 may be configured to determine an identifier corresponding to a LUT, provide the identifier and an input lattice to a trained machine learning model, obtain, from the trained machine learning model, an output lattice corresponding to the LUT, and performing color manipulation on at least one image using the output lattice.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A non-transitory memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two (2) or more components shown in FIG. 1 may be implemented within a single component, or a single component shown in FIG. 1 may be implemented as multiple, distributed components. Alternatively or additionally, a set of (one or more) components shown in FIG. 1 may perform one or more functions described as being performed by another set of components shown in FIG. 1.

Having discussed an example of a device that may be used in providing and/or implementing various aspects of the present disclosure, a number of embodiments are now discussed in further detail. In particular, and as introduced above, some aspects of the present disclosure generally relate to encoding a LUT.

Color manipulation operations may be performed at several stages of computer vision and/or image processing applications. For example, color manipulation may be applied in various stages of image signal processing (ISP) pipelines to provide for colorimetric accuracy and/or to render different picture styles. As another example, color manipulation may be performed on images as part of photofinishing processes, such as, but not limited to, color grading in video editing processes. As yet another example, color manipulation filters (e.g., Instagram filters) may be applied to images in order to create particular effects on the images. These color manipulation operations may be performed using 3D color lookup tables (3D CLUTs) as such tables may be suitable for modeling complex transformations by sampling the target transformations on a 3D lattice. Consequently, electronic devices (e.g., smartphones, cameras, tablet computers, TVs, printers, or the like) may need to store significant numbers (e.g., dozens or more) of these LUTs in order to perform the above-described color manipulation operations. As used herein, 3D color lookup tables may be referred to as color lookup tables (CLUTs) and/or lookup tables (LUTs).

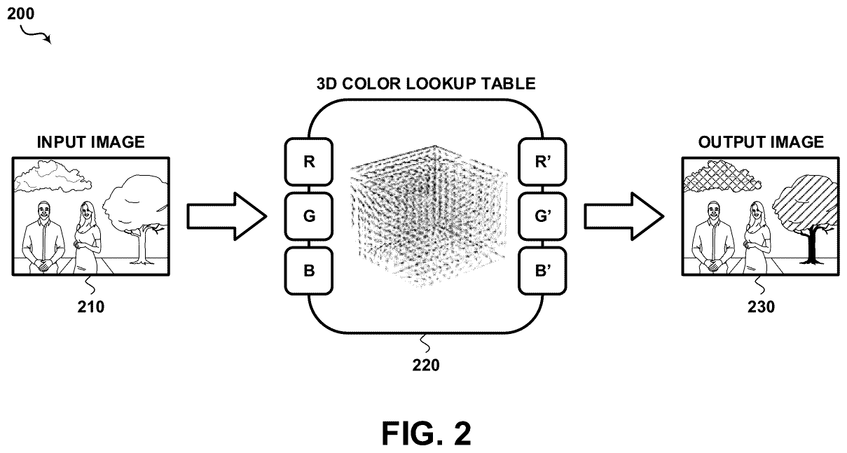

FIG. 2 depicts an example of a color manipulation operation, in accordance with various aspects of the present disclosure.

Referring to FIG. 2, a color manipulation operation 200 that implements one or more aspects of the present disclosure is illustrated. In some embodiments, at least a portion of the color manipulation operation 200 as described with reference to FIG. 2 may be performed by the device 100 of FIG. 1, which may include the LUT encoding component 180. Alternatively or additionally, another computing device (e.g., a UE, a server, a laptop, a smartphone, a camera, a wearable device, a smart device, a TV, a printer, an IoT device, or the like) that may include the LUT encoding component 180 may perform at least a portion of the color manipulation operation 200. That is, the device 100 may perform a portion of the color manipulation operation 200 as described with reference to FIG. 2 and a remaining portion of the color manipulation operation 200 may be performed by one or more other computing devices.

As shown in FIG. 2, the color manipulation operation 200 may include transforming the color values of an input image 210 to the color values of the output image 230 using a 3D color lookup table (LUT) 220. That is, input color values (e.g., a red input color R, a green input color G, and a blue input color B) of the input image 210 may be transformed to output color values (e.g., a red output color R′, a green input color G′, and a blue input color B′) of the output image 230 based on the color mappings (encodings) included in the LUT 220.

In an embodiment, the LUT 220 may be stored as a 3D input-output lattice, where the input lattice may be set to a uniform grid at fixed intervals along the red R, green G, and blue B color axes, and the output lattice may include the output color values (e.g., the red output color R′, the green input color G′, and the blue input color B′) corresponding to the input lattice. In such an embodiment, the color manipulation operation 200 may include determining a suitable transformation of the input color values by sampling a target transformation on the 3D output lattice of the LUT 220. For example, the output color values may be determined by interpolating the input color values within the 3D input lattice along the red R, green G, and blue B input color axes and calculating the corresponding output color values within the 3D output lattice along the red R′, green G′, and blue B′ output color axes.

As the input lattice of the LUT 220 may be a predetermined uniform grid, the LUT 220 may only need to store the output lattice. That is, assuming that the input lattice is known, the LUT 220 may only need to store the corresponding output lattice. In an embodiment, the LUT 220 may store the actual output color value corresponding to each of the input color values. Alternatively or additionally, the LUT 220 may store a delta value (e.g., a difference) representing the change to the input value that needs to be applied to generate the output value. In an embodiment, the LUT 220 may be stored as an American Standard Code for Information Interchange (ASCII) file and/or as a universal character encoding (Unicode) file, for example, a .cube file. Alternatively or additionally, the LUT 220 may be stored as a binary array of floating-point values. However, the present disclosure is not limited in this regard, and the LUT 220 may be stored in various other formats without departing from the scope of the present disclosure.

In an embodiment, the 3D LUT 220 may be flattened into a two-dimensional (2D) image that includes an arrangement of all possible colors. This flattened representation of the LUT 220 may be referred to as a Hald image. Hald images may serve to visualize how the LUT 220 manipulates colors over the entire color space (e.g., RGB). The Hald image may be stored as an RGB image. For example, the Hald image may be stored in a lossless format such as, but not limited to, a portable network graphics (png) format, a graphics interchange format (gif), or the like.

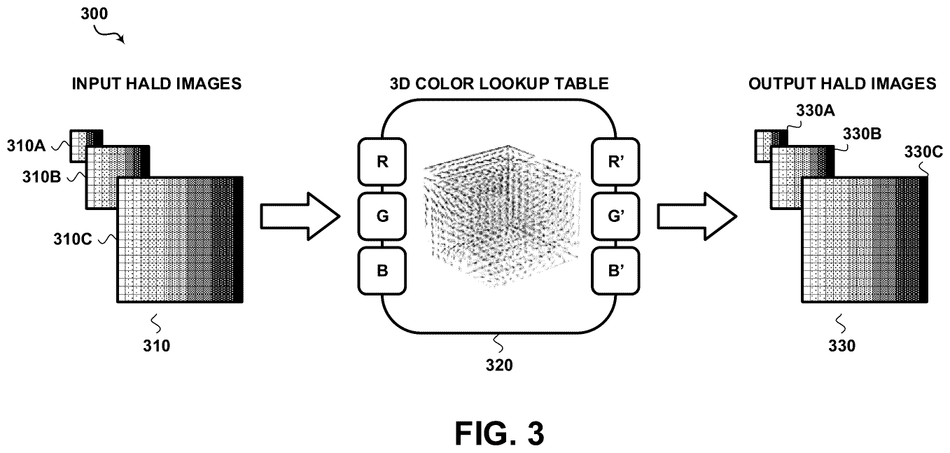

FIG. 3 illustrates an example of a color manipulation operation 300 using Hald images, in accordance with various aspects of the present disclosure. The color manipulation operation 300 depicted in FIG. 3 may be similar in many respects to the color manipulation operation 200 described above with reference to FIG. 2, and may include additional features not mentioned above. Consequently, repeated descriptions of the color manipulation operation 300 described above with reference to FIG. 2 may be omitted for the sake of brevity.

Input Hald images 310 (e.g., a first input Hald image 310A, a second input Hald image 310B, and a third input Hald image 310C) may be adjusted to mimic difference LUT resolutions. For example, the first input Hald image 310A may correspond to a LUT having a 16×16×16 resolution, and may be referred to as a 16³ Hald image. As another example, the second input Hald image 310B may correspond to a LUT having a 64×64×64 resolution, and may be referred to as a 64³ Hald image. As another example, the third input Hald image 310C may correspond to a LUT having a 256×256×256 resolution, and may be referred to as a 256³ Hald image. As described above with reference to FIG. 2, the 3D LUT 320 may generate output Hald images 330 corresponding to the input Hald images 310 at the resolutions of the input Hald images. For example, the LUT 320 may generate a 16³ output Hald image 330A based on the first input Hald image 310A. As another example, the 320 may generate a 163 output Hald image 330A based on the first input Hald image 310A. As another example, the 320 may generate a 163 output Hald image 330A based on the first input Hald image 310A.

A single LUT may need a relatively manageable amount of memory storage. For example, a low resolution 33×33×33 LUT at a 32-bit precision may need about 170 kilobytes (KB) of memory storage. As described above, electronic devices (e.g., smartphones, cameras, tablet computers, TVs, printers, or the like) may need to store significant numbers (e.g., dozens or more) of these LUTs, and consequently, the memory storage needed to store the LUTs may impose a significant burden on the memory resources available to the electronic devices. To that end, related color manipulation approaches may have attempted to reduce the memory footprint (e.g., memory resource usage) of the LUTs by targeting individual LUTs and applying known compression algorithms to the individual LUT files and generating compressed versions of the LUT files, such as, but not limited to, zip archive files (e.g., .zip files). However, such data compression approaches may typically be limited to compression rates of about 30% that may be similar to the compression rates that may be achieved by lossless image file formats (e.g., .png files). That is, such data compression approaches may target individual LUT files and treat the content of such files as generic graphical data, and thus, may not contemplate similarities that may exist between the individual LUTs.

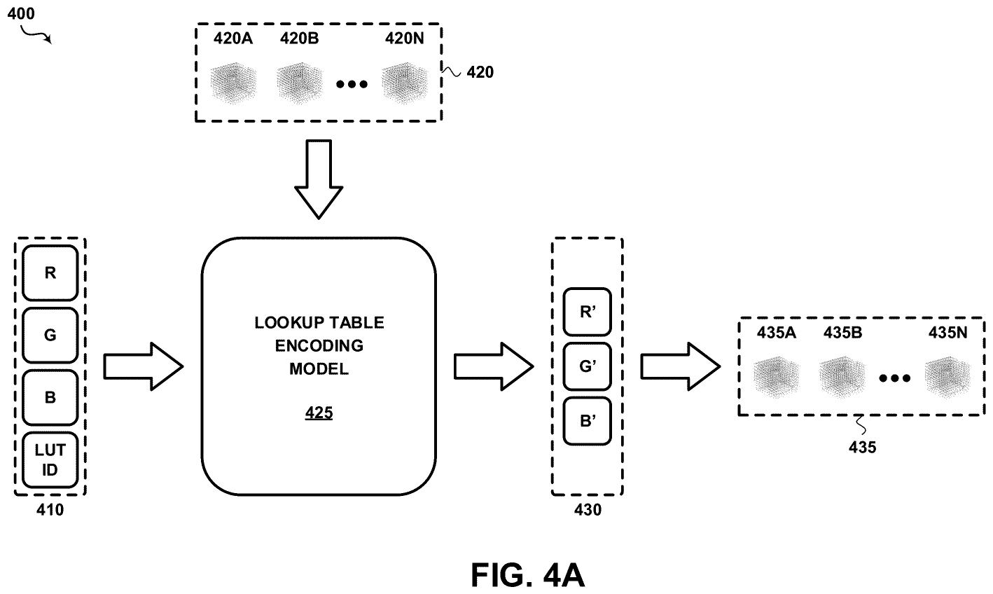

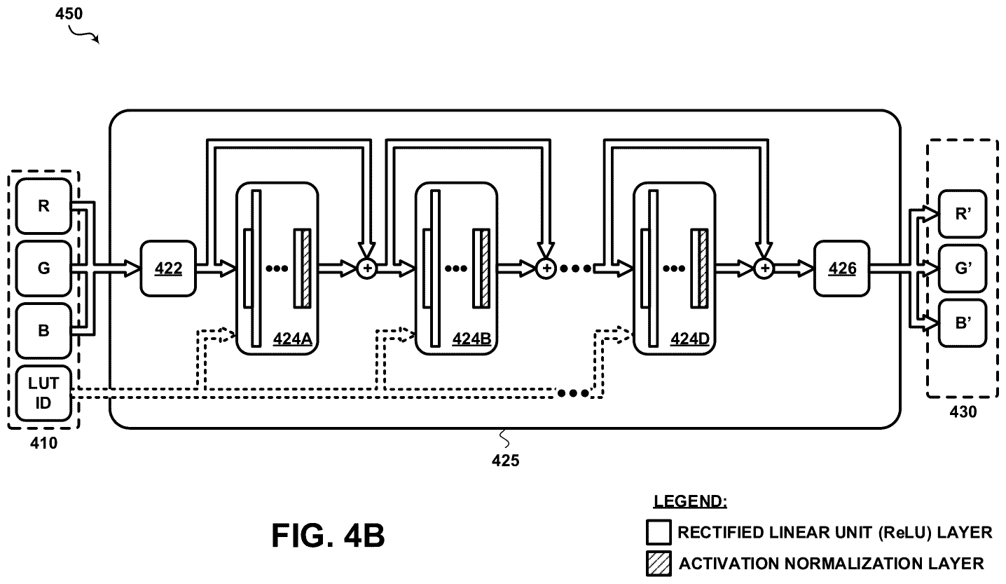

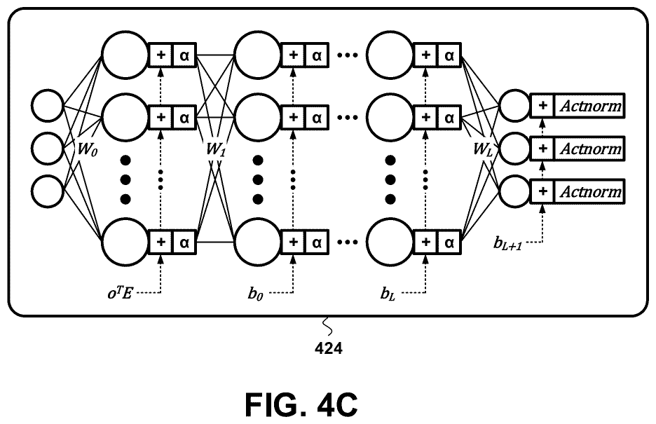

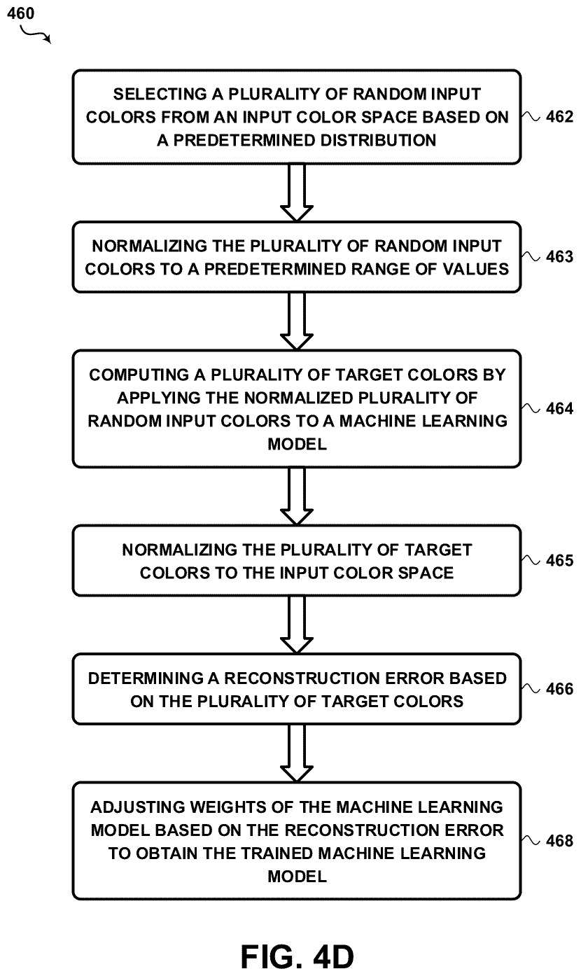

Aspects described herein may capitalize on the inherent similarities of the LUTs that may need to be stored by an electronic device, and thus, may achieve improved compression rates when compared to related data compression approaches. Aspects described herein may provide a compact machine learning model representation of the LUTs that may reconstruct each of the LUTs as requested, thereby potentially reducing memory storage needs and potentially enhancing real-time color manipulation capabilities, as described below with reference to FIGS. 4A to 9.

FIG. 4A depicts an example of a block diagram for encoding LUTs, in accordance with various aspects of the present disclosure.

Referring to FIG. 4A, a block diagram 400 that implements one or more aspects of the present disclosure is illustrated. In some embodiments, at least a portion of the block diagram 400 as described with reference to FIG. 4A may be performed by the device 100 of FIG. 1, which may include the LUT encoding component 180. Alternatively or additionally, another computing device (e.g., a UE, a server, a laptop, a smartphone, a camera, a wearable device, a smart device, a TV, a printer, an IoT device, or the like) that may include the LUT encoding component 180 may perform at least a portion of the block diagram 400. That is, the device 100 may perform a portion of the block diagram 400 as described with reference to FIG. 4A and a remaining portion of the block diagram 400 may be performed by one or more other computing devices.

In some embodiments, the block diagram 400 depicted in FIG. 4A may be used to implement at least a portion of the color manipulation operations 200 and 300 described above with reference to FIGS. 2 and 3, and may include additional features not mentioned above.

As shown in FIG. 4A, the block diagram 400 for encoding LUTs may include a lookup table (LUT) encoding model 425 that may have been trained and/or configured to reconstruct a plurality of input LUTs (e.g., a first input LUT 420A, a second input LUT 420B, to an n-th input LUT 420N, where n is a positive integer greater than zero (0), hereinafter generally referred to as “420”). The LUT encoding model 425 may be provided an input 410 that may include one or more red input R values, one or more green input G values, one or more blue input B values, and a LUT identifier (ID) and may be configured to generate output values 430 that may include one or more red output R′ values, one or more green output G′ values, one or more blue output B′ values that may correspond to a LUT of the plurality of input LUTs 420 indicated by the LUT ID included in the input 410.

The LUT ID included in the input 410 may indicate one or more LUTs of the plurality of input LUTs 420 that may be requested to be provided by the LUT encoding model 425. In an embodiment, the LUT ID may include a one-hot encoded index array having n elements, where each element of the index array corresponds a LUT of the plurality of input LUTs 420 and the corresponding index of the index array is set to a value (e.g., “1”, TRUE, “high”, or the like) to request the corresponding LUT of the plurality of input LUTs 420 and the remaining indexes of the index array are reset (e.g., set to “0”, FALSE, “low”, or the like). However, the present disclosure is not limited in this regard, and the LUT ID may include additional and/or alternative information indicating one or more LUTs from the plurality of input LUTs 420.

As each of the plurality of input LUTs 420 may consist of the output lattice values corresponding to predetermined input lattices, the LUT encoding model 425 may be used to reconstruct the input LUTs 420 as output LUTs (e.g., a first output LUT 435A, a second output LUT 435B, to an n-th output LUT 435, generally referred to as 435) that may be substantially similar and/or the same as the corresponding plurality of input LUTs 420. That is, the plurality of output LUTs 435 may differ from the plurality of input LUTs 420 by an average color difference ΔE that may be less than or equal to 2.0, which may be an acceptable perceptual color distortion according to industry standards.

As the LUT encoding model 425 may be simultaneously trained on the plurality of input LUTs 420, the LUT encoding model 425 may capitalize of the inherent similarities of the plurality of input LUTs 420, which may result in the LUT encoding model 425 having a significantly reduced memory resource footprint, when compared to a memory storage needed to store the plurality of input LUTs 420, even in a compressed format. For example, a memory storage needed to store 512 LUTs (e.g., n=512) may be about 124 megabytes (MB), whereas a memory resource footprint of a LUT encoding model 425 configured to reconstruct the 512 LUTs may be about 234 kilobytes (KB). However, the present disclosure is not limited in this regard, and other compression rates may be achieved.

A 3D color LUT (e.g., input LUT 420, output LUT 435) may be represented by a function F: [symbol] ³→ [symbol] ³ that maps input colors (e.g., RGB) to output colors (e.g., RGB) represented by a set of input-output pairs on a sparse lattice covering the input color space (e.g., RGB). In an embodiment, the function F may compute the output color of an arbitrary input using conventional interpolation techniques.

Given a set of LUTs {F₁, F₂, . . . , F_{N}} (e.g., the plurality of input LUTs 420), an implicit neural representation may be found and may be represented as an equation similar to Equation 1.

$${f}_{θ} ( \cdot , o ) : {ℝ}^{3} \times ℒ \to {ℝ}^{3} \qquad [ Eq . 1 ]$$

Referring to Equation 1, [symbol] ⊂ [symbol] ^{N} may represent the set of LUTs and f may represent a function modeled with a deep neural network that may be parameterized by θ. The function f_{θ} may take on an RGB color input in addition to a requested LUT Fᵢ (e.g., input 410), represented with a one-hot encoded vector Oᵢ∈ [symbol] .

The parameters θ may be learned and/or optimized, through training of the LUT encoding model 425, such that f_{θ}(·, Oᵢ)≈Fᵢ(·), as represented by an equation similar to Equation 2.

$${θ}^{*} = {arg min}_{θ} {𝔼}_{x ∼ 𝒫} [ {\sum }_{i}^{N} {‖ {f}_{θ} ( x , {O}_{i} ) - {F}_{i} ( x ) ‖}_{2}^{2} ] \qquad [ Eq . 2 ]$$

Referring to Equation 2, [symbol] may represent a probability distribution over the input colors. Thus, different choices for [symbol] may result in different θ's that may trade off better reconstruction of certain colors over the remaining colors of the color space. That is, the choice of [symbol] may depend on an intended use case of f_{θ}_{^{−}} and/or design constraints. For example, the closer [symbol] is to an evaluation distribution, the better f_{θ}_{^{−}} may trade off the quality of color reconstructions over out-of-distribution colors.

As discussed above, the plurality of LUTs 420 may exhibit similarities between the individual LUTs. For example, the plurality of LUTs 420 may frequently resemble an identify function in one or more regions of the input space (e.g., RGB). That is, the output colors generated by the plurality of LUTs 420 in the one or more regions may match the input colors. As another example, the plurality of LUTs 420 may exhibit local bijectivity. That is, there may be a one-to-one correspondence between the input colors and the output colors generated by a LUT 420. As a result, an inverse of the LUT 420 may be used to revert the output image back to the input image. However, a LUT 420 that intentionally manipulates a color space by compressing that color space into lower-dimensional manifolds may not exhibit local bijectivity. For example, a LUT 420 that converts an RGB image into a grayscale image may not exhibit local bijectivity.

FIG. 4B illustrates an example architecture of a LUT encoding model, in accordance with various aspects of the present disclosure. FIG. 4C depicts an example architecture of a residual component as shown in FIG. 4C, in accordance with various aspects of the present disclosure.

The architecture of the LUT encoding model 425 depicted in FIG. 4B may be similar in many respects to the block diagram 400 described above with reference to FIG. 4A and may include additional features not mentioned above. Some of the elements of the block diagram 400 described above may have been omitted for the sake of simplicity.

The LUT encoding model 425 may be designed and/or configured to capture the LUT characteristics described above. That is, the LUT encoding model 425 may take into consideration that portions of LUTs may resemble an identity function and/or may exhibit local bijectivity. The LUT encoding model 425 may be and/or may include a trained machine learning model such as, but not limited to, a residual network (e.g., ResNet), or the like. Residual networks may have an inductive bias toward an identity function, and as such, may be well suited to account for (or model) the resemblance of LUTs to an identity function. However, the present disclosure is not limited in this regard, and other networks and/or models may be used without departing from the scope of the present disclosure. Notably, the aspects presented herein may be employed with any network and/or model capable of encoding a plurality of LUTs.

In an embodiment, the LUT encoding model 425 may include architectural elements from normalizing flows. As used herein, normalizing flows may refer to a class of bijective neural networks that may be used for generative modeling and density estimation. That is, the LUT encoding model 425 may be and/or may include a residual network that may have been modified with an inductive bias towards bijective maps.

For example, if residual functions in the residual network have a Lipschitz constant that is capped to one (1) or less, the residual network may be invertible according to the Banach fixed point theorem. In addition, each residual function may be explicitly restricted through spectral normalization and activation functions that have bounded derivatives. However, given that not all LUTs are bijective (e.g., RGB to grayscale), the LUT encoding model 425 may not be rigidly restricted to bijectivity. Instead, the LUT encoding model 425 may be initialized close to such a bijective transformation as a form of inductive bias to regularize learning. That is, prior to training, the LUT encoding model 425 may be initialized in a substantially bijective state but may be allowed to migrate away from that state during training as needed.

Referring to FIG. 4B, the LUT encoding model 425 may include a plurality of residual components (e.g., a first residual component T₁ 424A, a second residual component T₂ 424B, to a D-th residual component T_{D} 424D, where D is a positive integer greater than zero (0), hereinafter generally referred to as “424”). Each of the plurality of residual components 424 may contribute to the reconstructed output color through consecutive residual functions. Although FIG. 4B depicts three (3) residual components 424, the present disclosure is not limited in this regard. For example, the LUT encoding model 425 may include fewer residual components (e.g., two (2) or less) or may include more residual components (e.g., four (4) or more). In an embodiment, the number of residual components may be determined based on design constraints, such as, but not limited to, the number of LUTs in the plurality of input LUTs 420 that may be embedded into the LUT encoding model 425. That is, a larger number of residual components may result in a better reconstruction of higher numbers of LUTs.

As shown in FIG. 4C, each of the plurality of residual components 424 may be and/or may include a multi-layer perceptron (MLP) with α LipSwish non-linearities, where the biases of the first layer may be selected based on the one-hot encoded vector O of the requested LUT. Each of the plurality of residual components 424 may be conditioned on the requested LUT Oᵢ by a learned matrix Eᵢ∈ [symbol] ^{N×h}, where N may represent the number of LUTs in the plurality of input LUTs 420, and h may represent the width of the first hidden layer in the residual component 424. The one-hot encoded vector O may select a row from the learned matrix Eᵢ (O^{T}Eᵢ) that may be used as the biases for the first hidden layer in the residual component 424.

Continuing to refer to FIG. 4C, activation normalization may be used to potentially mitigate numerical instabilities that may be caused by stacking multiple residual functions together (e.g., the first residual component T₁ 424A, the second residual component T₂ 424B, or the like). In order to ensure that the LUT encoding model 425 contains identity and bijective functions, the weights (e.g., first weights W₀, second weights W₁, to L-th weights W_{L}) and biases (e.g., first biases b₀, to L-th biases b_{L}, and (L+1)-th biases b_{L+1}) of the LUT encoding model 425 may be initialized with relatively small values (e.g., one (1) or less) and/or may use LipSwish non-linearities with bounded derivatives.

Returning to FIG. 4B, the LUT encoding model 425 may apply a normalization function 422 to the color values of the input 410 to convert the color values into a bounded normalized input-output space. Additionally, the LUT encoding model 425 may apply a denormalization function 426 to return the color values back to the bounded color space (e.g., RGB). In an embodiment, the normalization function 422 may be represented by a function similar to an arc tangent function (e.g., tan⁻¹) and the denormalization function 426 may be represented by a function similar to a tangent function (e.g., tan). However, the present disclosure is not limited in this regard, and the normalization and denormalization functions 422 and 426 may be represented by other similar functions without departing from the scope of the present disclosure.

By applying the normalization and denormalization functions 422 and 426, the LUT encoding model 425 may operate closer to the local identity and a bijective function and operate in an unbounded space with similar input-output measures. In addition, computational capabilities of the LUT encoding model 425 may be potentially improved, such as, but not limited to, avoiding large increases in the network weights to produce saturated colors. As such, the LUT encoding model 425 may potentially reduce or prevent the clipping of gradient values, when compared to related color manipulation approaches.

In an embodiment, the LUT encoding model 425 may be trained to simultaneously embed the plurality of input LUTs 420 on a custom color distribution [symbol] , as described with reference to FIG. 4D.

FIG. 4D illustrates a flowchart of an example method for training a LUT encoding model, in accordance with various aspects of the present disclosure.

Referring to FIG. 4D, a method 460 for training the LUT encoding model 425 that implements one or more aspects of the present disclosure is illustrated. In some embodiments, at least a portion of the training method 460 as described with reference to FIG. 4D may be performed by the device 100 of FIG. 1, which may include the LUT encoding component 180. Alternatively or additionally, another computing device (e.g., a UE, a server, a laptop, a smartphone, a camera, a wearable device, a smart device, a TV, a printer, an IoT device, or the like) that may include the LUT encoding component 180 may perform at least a portion of the training method 460. That is, the device 100 may perform a portion of the training method 460 as described with reference to FIG. 4D and a remaining portion of the training method 460 may be performed by one or more other computing devices.

In operation 462, the training method 460 may include selecting a plurality of random input colors from an input color space based on a predetermined distribution. In an embodiment, the plurality of random input colors may be randomly selected from an input color space (e.g., a 256³ color space).

In operation 463, the training method 460 may include normalizing the plurality of random input colors to a predetermined range of values. In an embodiment, all colors may be encoded with 8-bits per RGB channel. In such an embodiment, a color c may be normalized using an equation similar to Equation 3.

$$\overline{c} = 2 a ( \frac{c}{255} - \frac{1}{2} ) \qquad [ Eq . 3 ]$$

Referring to Equation 3, c̅∈[−a, a], which may bind the input space for training. The value a may be used to avoid saturation of the subsequent normalization function 422 (e.g., tanh⁻¹ transform) and to reduce or prevent the clipping of gradient values. For example, the value of a may be set to 0.83 (e.g., a=0.83). However, the present disclosure is not limited in this regard, and the value of a may be set to other values without departing from the scope of the present disclosure. Notably, the value of a may be set to any value that results in a derivative of the normalization function 422 having a value larger (greater) than ½.

In an embodiment, the normalization may be inverted for evaluating and/or visualizing results, and the values may be clipped to be in [0, 1] and then scaled and quantized back to 8-bit values.

In operation 464, the training method 460 may include computing a plurality of target colors by applying the normalized plurality of random input colors to the LUT encoding model 425. In an embodiment, only a subset of the normalized plurality of random input colors may be provided to the LUT encoding model 425. In another embodiment, all input colors may be processed with the LUT encoding model 425 to produce target color values. Alternatively or additionally, all LUTs in the plurality of input LUTs 420 may be targeted at each training iteration.

In operation 465, the training method 460 may include normalizing the plurality of target colors back to the input color space. That is, the denormalization function 426 (e.g., tanh transform) may be applied to the plurality of target colors.

In operation 466, the training method 460 may include determining a reconstruction error, such as, but not limited to, an L2 reconstruction error, based on the plurality of target colors.

In operation 468, the training method 460 may include adjusting weights of the LUT encoding model 425 based on the reconstruction error to obtain the trained LUT encoding model 425. For example, the LUT encoding model 425 may be optimized using an Adam optimizer with default settings and a stepped learning rate schedule. However, the present disclosure is not limited in this regard, and the LUT encoding model 425 may be optimized using other algorithms and/or other settings in those algorithms without departing from the scope of the present disclosure.

In an embodiment, the LUT encoding model 425 may be trained by sampling the plurality of input LUTs 420 over an entire color space. As used herein, such training may be referred to as uniform sampling as every color in the color space may be weighted equally. Alternatively or additionally, the LUT encoding model 425 may be trained by sampling the plurality of input LUTs 420 over a custom color distribution [symbol] . For example, the color distribution [symbol] may be determined based on a color distribution of the training images. That is, the LUT encoding model 425 may be trained only using colors that may have a relatively high probability of occurring in the training images. In such an example, a relatively large portion of the color space (e.g., >85%) may not occur in the training images. Consequently, by focusing training on the colors that are likely to occur, training of the LUT encoding model 425 may be performed more efficiently without potentially impacting the performance of the LUT encoding model 425. That is, while using uniform sampling to train the LUT encoding model 425 may improve a general performance of the LUT encoding model 425 across all possible colors, training the LUT encoding model 425 using a custom color distribution [symbol] may provide for an enhanced performance over the expected color images that may be applied to the LUT encoding model 425.

Operations 462 to 468 of the training method 460 may be repeated until the training of the LUT encoding model 425 is determined to be completed. For example, the training may be determined to be completed when a predetermined number of iterations have been completed. In another example, the training may be determined to be completed when an average value of the weight adjustments is below a predetermined threshold. In another example, the training may be determined to be completed when a quality of the LUT approximations provided by the LUT encoding model 425 is within a predetermined quality threshold. However, the present disclosure is not limited in this regard, and the training of the LUT encoding model 425 may be determined based on additional conditions and/or a combination of conditions.

In an embodiment, the quality of the LUT approximations provided by the LUT encoding model 425 may be evaluated using one or more metrics that may interpret the LUT approximations in terms of human perception. For example, in an embodiment, a CIE₇₆ average color difference ΔE may be used to evaluate the LUT encoding model 425. In such an example, two (2) colors having an average color difference less than or equal to two (2) (e.g., ΔE≤2) may be considered as being indistinguishable for an average observer. However, the present disclosure is not limited in this regard, and the LUT encoding model 425 may be using other metrics.

Since the average color difference ΔE is computed per-color pair, general statistics of average color difference ΔEs over the set of evaluation colors may be tracked in order to estimate overall qualities of the color reconstructions performed by the LUT encoding model 425. In an embodiment, the tracked statistics may include, but not be limited to, ΔE_{q %} and ΔE_{M}, which may respectively denote the q-th quantile and the empirical mean of ΔEs over a particular evaluation set. In addition, since the LUT encoding model 425 may embed multiple LUTs at a time, the statistics may be averaged over all the plurality of input LUTs 420 in the LUT encoding model 425 to get Δ̅Es. For example, a LUT encoding model 425 with Δ̅E_{90%}<2 may reconstruct 90% of the evaluated colors with a ΔE<2 on average over the plurality of input LUTs 420 embedded in the LUT encoding model 425.

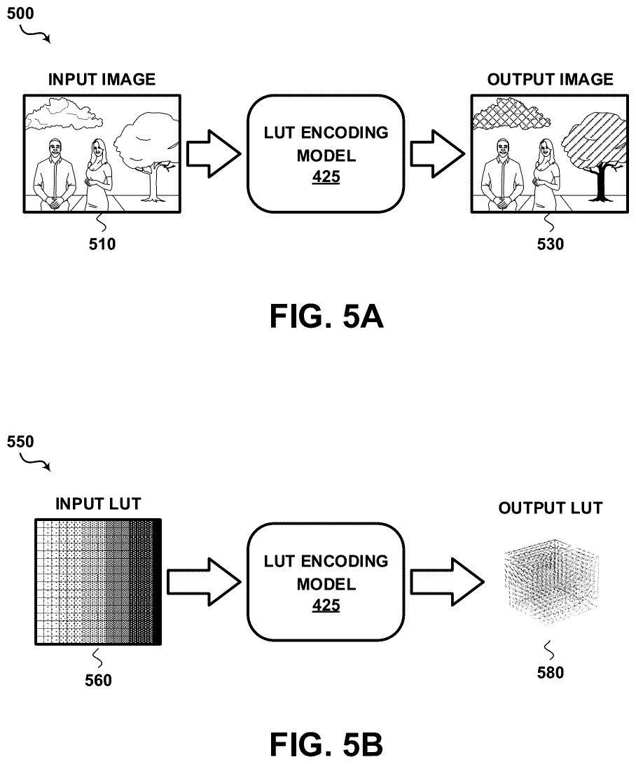

FIGS. 5A and 5B depict example use cases of a LUT encoding model, in accordance with various aspects of the present disclosure.

Referring to FIGS. 5A and 5B, a first use case 500 and a second use case 550 that implement one or more aspects of the present disclosure are illustrated. In some embodiments, at least a portion of the first and second use cases 500 and 550 as described with reference to FIGS. 5A and 5B may be performed by the device 100 of FIG. 1, which may include the LUT encoding component 180. Alternatively or additionally, another computing device (e.g., a UE, a server, a laptop, a smartphone, a camera, a wearable device, a smart device, a TV, a printer, an IoT device, or the like) that may include the LUT encoding component 180 may perform at least a portion of the first and second use cases 500 and 550. That is, the device 100 may perform a portion of the first and second use cases 500 and 550 as respectively described with reference to FIGS. 5A and 5B and a remaining portion of the first and second use cases 500 and 550 may be performed by one or more other computing devices.

The first and second use cases 500 and 550 respectively depicted in FIGS. 5A and 5B may be similar in many respects to the color manipulation operations 200 and 300 described above with reference to FIGS. 2 and 3, and may include additional features not mentioned above. Consequently, repeated descriptions of the first and second use cases 500 and 550 described above with reference to FIGS. 2 and 3 may be omitted for the sake of brevity.

As shown in FIG. 5A, the LUT encoding model 425 may be provided with an input image 510 (e.g., an RGB image) and a corresponding output image 530 may be obtained in which the colors of the output image 530 may have been manipulated by the LUT encoding model 425 according to a specified LUT of the plurality of input LUTs 420. In an embodiment, the resolution of the output image 530 may match the resolution of the input image 510. Alternatively, the resolution of the output image 530 may be different from the resolution of the input image 510. Although FIG. 5A depicts a single input image 510 being provided to the LUT encoding model 425, the present disclosure is not limited in this regard. For example, the LUT encoding model 425 may be provided by two (2) more input images 510 and the LUT encoding model 425 may process the provided images in a sequential and/or substantially parallel manner. That is, the LUT encoding model 425 may provide the corresponding output images 530 sequentially and/or substantially simultaneously.

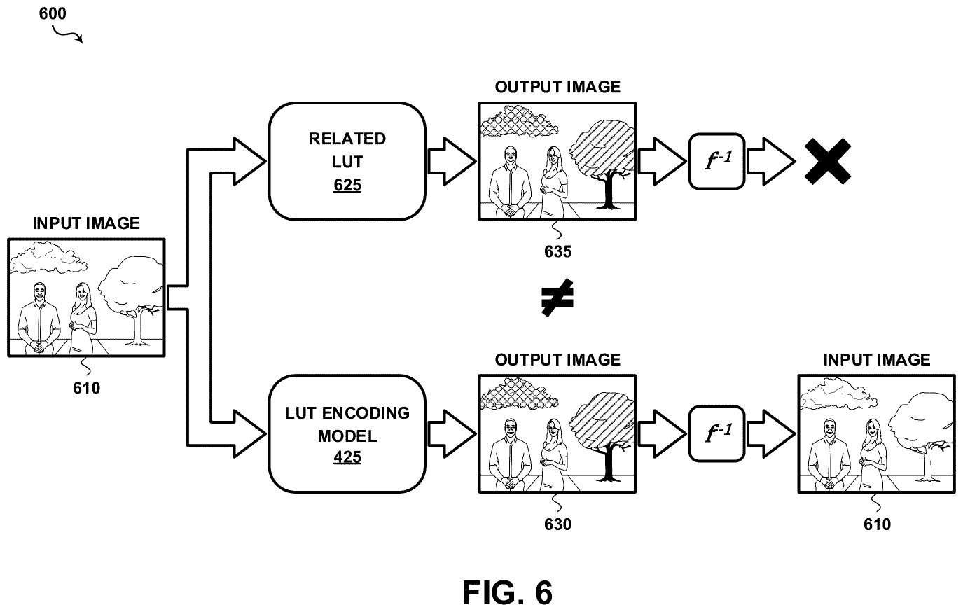

In an embodiment, the LUT encoding model 425 may perform a bijective color transformation on the input image 510, such that, the original input image 510 may be obtained by performing an inverse of the color transformation on the output image 530. Such color transformations are described further with reference to FIG. 6.

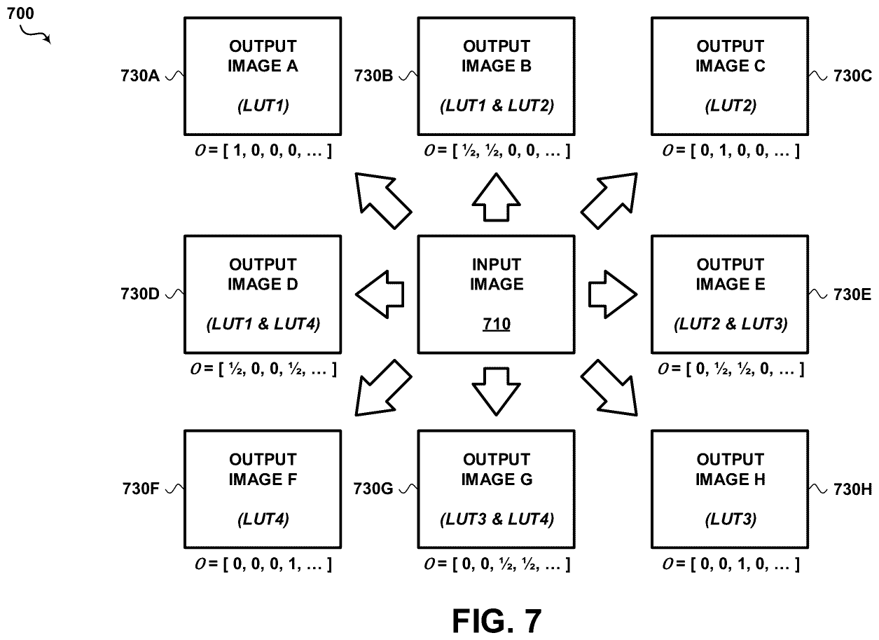

In an embodiment, the LUT encoding model 425 may perform a color transformation on the input image 510 using a blend of two (2) or more LUTs of the plurality of input LUTs 420 embedded in the LUT encoding model 425. Such color transformations are described further with reference to FIG. 7.

As shown in FIG. 5B, an input LUT and/or input lattice 560 may be provided to the LUT encoding model 425 and a corresponding output LUT 580 may be obtained. That is, the LUT encoding model 425 may be used to reconstruct a LUT of the plurality of input LUTs 420 that may be embedded in the LUT encoding model 425. In an embodiment, the resolution of the output LUT 580 may match the resolution of the input LUT and/or input lattice 560. Alternatively, the resolution of the output LUT 580 may be different from the resolution of the input LUT and/or input lattice 560. In an embodiment, the LUT encoding model 425 may be referred to as an implicit representation.

In an embodiment, the output lattice 560, which corresponds to a reconstructed LUT of the plurality of input LUTs 420, may be provided to an ISP and/or dedicated processing hardware (e.g., dedicated accelerator hardware) to perform the lookup table computations.

FIG. 6 illustrates an example of bijective transformations using a comparative example and a LUT encoding model, in accordance with various aspects of the present disclosure.

Referring to FIG. 6, a comparison of a color transformation using a related LUT 625 with an example of a bijective transformation using the LUT encoding model 425 that implements one or more aspects of the present disclosure is illustrated.

As shown in FIG. 6, an output image 635 may be generated by applying a related LUT 625 to an input image 610. As the related LUT 625 may not perform a bijective transformation, an accurate inversion of the output image 635 may be non-trivially difficult.

In an embodiment, the LUT encoding model 425 may be initialized near the space of bijective transformations, as described above with reference to FIG. 4B. Alternatively or additionally, the LUT encoding model 425 may be kept in a bijective state during training by explicitly restricting the LUT encoding model 425 to the space of bijective functions. For example, spectral normalizations may be used to normalize the weights (e.g., the first to L-th weights W₀ to W_{L}) of each residual component (e.g., the first to D-th residual components 424A to 424D) by a respective largest singular value to enforce a Lipschitz constant that may have a value less than one (1) (e.g., 0.97). In an embodiment, the restricting of the weights in combination with the activation functions of the residual components may restrict the LUT encoding model 425 to remain bijective during training, and as such, the LUT encoding model 425 may reconstruct the closest invertible approximation of the plurality of input LUTs 420 embedded in the LUT encoding model 425 even if the input LUT 420 is not intrinsically bijective. In addition, the bijective LUT encoding model 425 may provide for the network (or architecture) of the LUT encoding model 425 to be inverted with a fixed-point iteration.

The output of the LUT encoding model 425 may be inverted by first applying a normalization function (e.g., normalization function 422) to the outputs of the LUT encoding model 425. Subsequently, starting with a last residual component (e.g., the residual component 424D), each residual component may be inverted using, for example, a fixed-point algorithm. Finally, a denormalization function (e.g., denormalization function 426) may be applied to the final results to return to the original input space.

Continuing to refer to FIG. 6, an output image 630 may be generated by applying a LUT encoding model 425 to the input image 610. In addition, as the LUT encoding model 425 may perform a bijective transformation on the input image 610, the originally provided input image 610 may be obtained by applying an inverse function to the output image 630. Consequently, the output image 635 generated by the related LUT 625 may not be identical to the output image 630 generated by the LUT encoding model 425.

In an embodiment, restricting the architecture of the LUT encoding model 425 to be bijective may slightly decrease the modeling capacity of the LUT encoding model 425, and thus, a LUT encoding model 425 configured be bijective may need additional residual components 424D to provide a comparable embedding performance to similar LUT encoding models 425 that may not have been restricted in such a manner.

FIG. 7 depicts an example of LUT blending, in accordance with various aspects of the present disclosure.

Referring to FIG. 7, LUT blending operations 700 using the LUT encoding model 425 that implement one or more aspects of the present disclosure are illustrated. In some embodiments, at least a portion of the LUT blending operations 700 as described with reference to FIG. 7 may be performed by the device 100 of FIG. 1, which may include the LUT encoding component 180. Alternatively or additionally, another computing device (e.g., a UE, a server, a laptop, a smartphone, a camera, a wearable device, a smart device, a TV, a printer, an IoT device, or the like) that may include the LUT encoding component 180 may perform at least a portion of the LUT blending operations 700. That is, the device 100 may perform a portion of the LUT blending operations 700 as described with reference to FIG. 7 and a remaining portion of the LUT blending operations 700 may be performed by one or more other computing devices.

As shown in FIG. 7, the LUT encoding model 425 may blend two (2) or more LUTs of the plurality of input LUTs 420 to produce new LUTs by varying the LUT ID (e.g., the one-hot encoded index array O) provided as an input to the LUT encoding model 425. For example, the LUT encoding model 425 may produce output images 730 from the input image 710 corresponding to one or more LUTs of the plurality of input LUTs 420 as described below.

The LUT encoding model 425 may produce a first output image 730A from the input image 710 corresponding to the first input LUT 420A when provided a one-hot encoded index array O in which the first index is set to a non-zero value (e.g., O=[1, 0, 0, 0, . . . ]).

The LUT encoding model 425 may produce a second output image 730B from the input image 710 corresponding to a blend of the first input LUT 420A and the second input LUT 420B when provided a one-hot encoded index array O in which the first index and the second index are set to a non-zero value (e.g.,

$$O = [ \frac{1}{2} , \frac{1}{2} , 0 , 0 , … ] ) .$$

The LUT encoding model 425 may produce a third output image 730C from the input image 710 corresponding to the second input LUT 420B when provided a one-hot encoded index array O in which the second index is set to a non-zero value (e.g., O=[0, 1, 0, 0, . . . ]).

The LUT encoding model 425 may produce a fourth output image 730D from the input image 710 corresponding to a blend of the first input LUT 420A and the fourth input LUT 420D when provided a one-hot encoded index array O in which the first index and the fourth index are set to a non-zero value (e.g.,

$$O = [ \frac{1}{2} , 0 , 0 , \frac{1}{2} , … ] ) .$$

The LUT encoding model 425 may produce a fifth output image 730E from the input image 710 corresponding to a blend of the second input LUT 420B and the third input LUT 420C when provided a one-hot encoded index array O in which the second index and the third index are set to a non-zero value (e.g.,

$$O = [ 0 , \frac{1}{2} , \frac{1}{2} , 0 , … ] ) .$$

The LUT encoding model 425 may produce a sixth output image 730F from the input image 710 corresponding to the fourth input LUT 420D when provided a one-hot encoded index array O in which the fourth index is set to a non-zero value (e.g., O=[0, 0, 0, 1, . . . ]).

The LUT encoding model 425 may produce a seventh output image 730G from the input image 710 corresponding to a blend of the third input LUT 420C and the fourth input LUT 420D when provided a one-hot encoded index array O in which the third index and the fourth index are set to a non-zero value (e.g.,

$$O = [ 0 , 0 , \frac{1}{2} , \frac{1}{2} , … ] ) .$$

The LUT encoding model 425 may produce an eighth output image 730H from the input image 710 corresponding to the third input LUT 420C when provided a one-hot encoded index array O in which the third index is set to a non-zero value (e.g., O=[0, 0, 1, 0, . . . ]).

In an embodiment, the blended LUTs may be used to produce blending effects in an ISP. Alternatively or additionally, the blended LUTs may be used as a starting point for designing new LUTs.

Advantageously, the methods, apparatuses, systems, and non-transitory computer-readable mediums for encoding LUTs, described above with reference to FIGS. 1 to 7, provide a LUT encoding model designed to efficiently encode 3D color lookup tables into a single compact representation. That is, the LUT encoding model may be designed to take advantage of common traits that may be found across LUTs, such as, but not limited to, resemblance to an identity function, exhibit local bijectivity, and ability to model colors of natural images while avoiding saturation points (e.g., dark/bright colors). Furthermore, the LUT encoding model may be trained to embed a significant number of LUTs simultaneously with relatively little additional computational cost when increasing the number of LUTs. In addition, the LUT encoding model may accommodate bijective encoding, thereby enabling the production of invertible LUTs and facilitating reverse color processing. Further, the LUT encoding model may blend two (2) or more LUTs to generate additional LUTs that may be used to produce blending effects and/or design new LUTs.

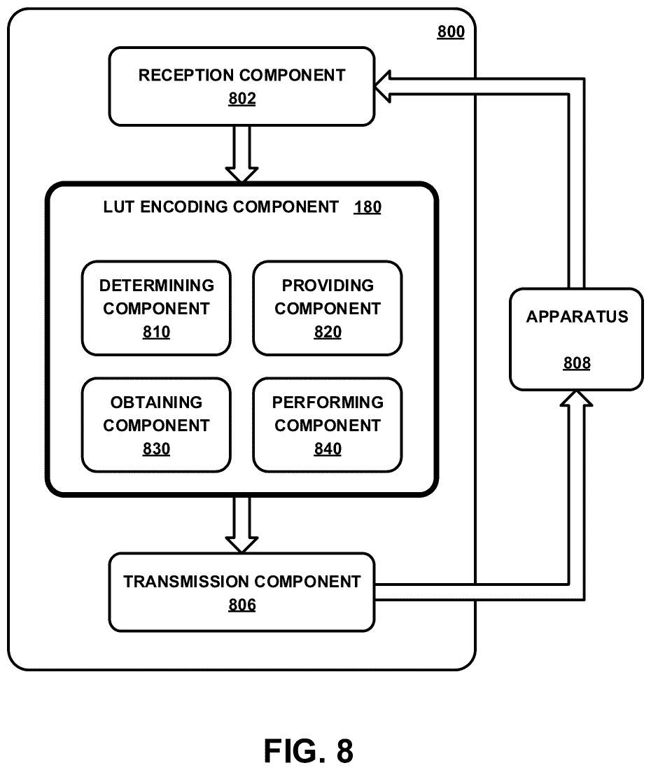

FIG. 8 depicts a block diagram of an example apparatus for encoding LUTs, in accordance with various aspects of the present disclosure. The apparatus 800 may be a computing device (e.g., device 100 of FIG. 1) and/or a computing device may include the apparatus 800. In some embodiments, the apparatus 800 may include a reception component 802 configured to receive communications (e.g., wired, wireless) from another apparatus (e.g., apparatus 808), a LUT encoding component 180 may be configured to perform color manipulation on input lattices based on a specified LUT, and a transmission component 806 configured to transmit communications (e.g., wired, wireless) to another apparatus (e.g., apparatus 808). The components of the apparatus 800 may be in communication with one another (e.g., via one or more buses or electrical connections). As shown in FIG. 8, the apparatus 800 may be in communication with another apparatus 808 (such as, but not limited to, a server, a laptop, a smartphone, a UE, a camera, a wearable device, a smart device, an IoT device, or the like) using the reception component 802 and/or the transmission component 806.

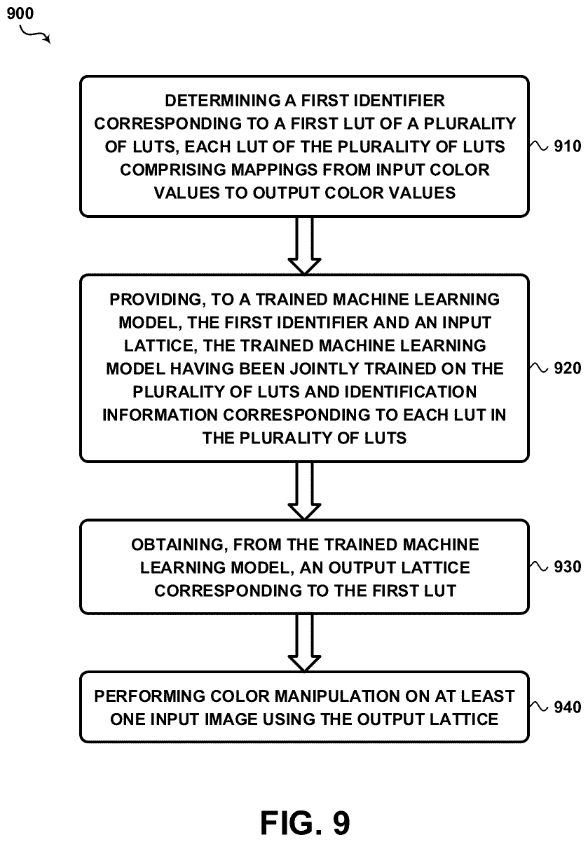

In some embodiments, the apparatus 800 may be configured to perform one or more operations described herein in connection with FIGS. 1 to 7. Alternatively or additionally, the apparatus 800 may be configured to perform one or more processes described herein, such as method 900 of FIG. 9. In some embodiments, the apparatus 800 may include one or more components of the device 100 described with reference to FIG. 1.

The reception component 802 may receive communications, such as control information, data communications, or a combination thereof, from the apparatus 808 (e.g., a server, a laptop, a smartphone, a UE, a camera, a wearable device, a smart device, an IoT device, or the like). The reception component 802 may provide received communications to one or more other components of the apparatus 800, such as the LUT encoding component 180. In some embodiments, the reception component 802 may perform signal processing on the received communications, and may provide the processed signals to the one or more other components. In some embodiments, the reception component 802 may include one or more antennas, a receive processor, a controller/processor, a memory, or a combination thereof, of the device 100 described with reference to FIG. 1.

The transmission component 806 may transmit communications, such as control information, data communications, or a combination thereof, to the apparatus 808 (e.g., a server, a laptop, a smartphone, a UE, a camera, a wearable device, a smart device, an IoT device, or the like). In some embodiments, the LUT encoding component 180 may generate communications and may transmit the generated communications to the transmission component 806 for transmission to the apparatus 808. In some embodiments, the transmission component 806 may perform signal processing on the generated communications, and may transmit the processed signals to the apparatus 808. In other embodiments, the transmission component 806 may include one or more antennas, a transmit processor, a controller/processor, a memory, or a combination thereof, of the device 100 described with reference to FIG. 1. In some embodiments, the transmission component 806 may be co-located with the reception component 802 such as in a transceiver and/or a transceiver component.

The LUT encoding component 180 may be configured to perform color manipulation on input lattices based on a specified LUT. In some embodiments, the LUT encoding component 180 may include a set of components, such as a determining component 810 configured to determine a LUT identifier, a providing component 820 configured to provide the LUT identifier and an input lattice to a trained machine learning model, an obtaining component 830 configured to obtain an output lattice corresponding to the identified LUT, and a performing component 840 configured to perform color manipulation on at least one input image using the output lattice.

In some embodiments, the set of components may be separate and distinct from the LUT encoding component 180. In other embodiments, one or more components of the set of components may include or may be implemented within a controller/processor (e.g., the processor 120), a memory (e.g., the memory 130), or a combination thereof, of the device 100 described above with reference to FIG. 1. Alternatively or additionally, one or more components of the set of components may be implemented at least in part as software stored in a memory, such as the memory 130. For example, a component (or a portion of a component) may be implemented as computer-executable instructions or code stored in a computer-readable medium (e.g., a non-transitory computer-readable medium) and executable by a controller or a processor to perform the functions or operations of the component.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIGS. 1 to 7.

Referring to FIG. 9, in operation, an apparatus 800 may perform a method 900 for encoding color lookup tables. The method 900 may be performed by at least one of the device 100 (which may include the processor 120, the memory 130, and the storage component 140, and which may be the entire device 100 and/or include one or more components of the device 100, such as the input component 150, the output component 160, the communication interface 170, and/or the LUT encoding component 180) and/or the apparatus 800. The method 900 may be performed by the device 100, the apparatus 800, and/or the LUT encoding component 180 in communication with the apparatus 808 (e.g., a server, a laptop, a smartphone, a UE, a camera, a wearable device, a smart device, an IoT device, or the like).

At block 910 of FIG. 9, the method 900 may include determining a first identifier corresponding to a first LUT of a plurality of LUTs, each LUT of the plurality of LUTs comprising mappings from input color values to output color values. For example, in an aspect, the device 100, the LUT encoding component 180, and/or the determining component 810 may be configured to or may include means for determining a first identifier corresponding to a first LUT of a plurality of LUTs 420, each LUT of the plurality of LUTs 420 comprising mappings from input color values to output color values.

For example, the determining at block 910 may be performed to identify the one or more LUTs from the plurality of LUTs 420 that are to be reconstructed by the LUT encoding component 180 and applied to the input lattice.

At block 920 of FIG. 9, the method 900 may include providing, to a trained machine learning model, the first identifier and an input lattice, the trained machine learning model having been jointly trained on the plurality of LUTs and identification information corresponding to each LUT in the plurality of LUTs. For example, in an aspect, the device 100, the LUT encoding component 180, and/or the providing component 820 may be configured to or may include means for providing, to a trained machine learning model 425, the first identifier and an input lattice 410, the trained machine learning model 425 having been jointly trained on the plurality of LUTs 420 and identification information corresponding to each LUT in the plurality of LUTs 420.

In some embodiments, the input lattice 410 may include a Hald image at a first resolution level, and the output lattice 430 may include the identified LUT at the first resolution level.

In optional or additional embodiments, a first resolution level of the output lattice 430 may match a second resolution level of the input lattice 410, and the first resolution level of the output lattice 430 may be different from a third resolution level of the identified LUT 420.

Further, for example, the providing at block 920 may be performed to provide the determined identification information of the one or more LUTs from the plurality of LUTs 420 and the input image and/or lattice for the LUT encoding model 425 to generate the output image and/or lattice.

At block 930 of FIG. 9, the method 900 may include obtaining, from the trained machine learning model, an output lattice corresponding to the first LUT. For example, in an aspect, the device 100, the LUT encoding component 180, and/or the obtaining component 830 may be configured to or may include means for obtaining, from the trained machine learning model 425, an output lattice 430 corresponding to the first LUT 420.

For example, the obtaining at block 930 may be performed to obtain the output image and/or lattice generated by the LUT encoding model 425.

At block 940 of FIG. 9, the method 900 may include performing color manipulation on at least one input image using the output lattice. For example, in an aspect, the device 100, the LUT encoding component 180, and/or the performing component 840 may be configured to or may include means for performing color manipulation on at least one input image 410 using the output lattice 430.

In some embodiments, the input lattice 410 may include a regularly spaced grid, and the output lattice 430 may include the identified LUT 420. In such an embodiment, the performing at block 940 may include applying the identified LUT 420, obtained from the trained machine learning model 425, to the at least one input image 410.

In optional or additional embodiments, the input lattice 410 may include the at least one input image, the output lattice 430 may include at least one color-manipulated image based on the identified LUT, and the at least one color-manipulated image may correspond to the at least one input image 410. In such an embodiment, the processing at block 940 may include providing the at least one color-manipulated image obtained from the trained machine learning model 425.

Further, for example, the performing at block 940 may be performed to generate an output image 410 using the output lattice 430 reconstructed by the LUT encoding model 425.

In optional or additional aspects that may be combined with any other aspects, the method 900 may further include selecting a plurality of random input colors from an input color space based on a predetermined distribution, normalizing the plurality of random input colors to a predetermined range of values, computing a plurality of target colors by applying the normalized plurality of random input colors to a machine learning model 425, normalizing the plurality of target colors to the input color space, determining a reconstruction error based on the plurality of target colors, and adjusting weights of the machine learning model 425 based on the reconstruction error to obtain the trained machine learning model 25.

In optional or additional aspects that may be combined with any other aspects, the predetermined distribution may include a uniform distribution of colors across the input color space.

In optional or additional aspects that may be combined with any other aspects, the method 900 may further include determining occurrence probabilities of colors in the input color space, and determining the predetermined distribution based on the colors in the input color space having an occurrence probability that exceeds a predetermined threshold.

In optional or additional aspects that may be combined with any other aspects, the method 900 may further include restricting the weights of the machine learning model 425 through spectral normalization and activation functions. In such aspects, the output lattice 430 may include an invertible approximation of the identified LUT 420.

In optional or additional aspects that may be combined with any other aspects, the method 900 may further include providing, to the trained machine learning model, a second identifier and the input lattice, and obtaining, from the trained machine learning model, another output lattice corresponding to a combination of the first LUT and the second LUT. In such aspects, the second identifier may indicate the first LUT and a second LUT of the plurality of LUTs 420.

The following aspects are illustrative only and aspects thereof may be combined with aspects of other embodiments or teaching described herein, without limitation.

Aspect 1 is a method for encoding LUTs by an apparatus. The method includes determining a first identifier corresponding to a first LUT of a plurality of LUTs, providing, to a trained machine learning model, the first identifier and an input lattice, obtaining, from the trained machine learning model, an output lattice corresponding to the first LUT, and performing color manipulation on at least one input image using the output lattice. Each LUT of the plurality of LUTs includes mappings from input color values to output color values. The trained machine learning model has been jointly trained on the plurality of LUTs and identification information corresponding to each LUT in the plurality of LUTs.

In Aspect 2, the method of Aspect 1 includes where the input lattice includes a regularly spaced grid, where the output lattice includes the first LUT, and where the performing of the color manipulation on the at least one input image includes applying the first LUT, obtained from the trained machine learning model, to the at least one input image.

In Aspect 3, the method of any of Aspects 1 or 2 includes where the input lattice includes the at least one input image, where the output lattice includes at least one color-manipulated image based on the first LUT, where the at least one color-manipulated image corresponds to the at least one input image, and where the performing of the color manipulation on the at least one input image includes providing the at least one color-manipulated image obtained from the trained machine learning model.

In Aspect 4, the method of any of Aspects 1 to 3 includes where the input lattice includes a Hald image at a first resolution level, and where the output lattice includes the first LUT at the first resolution level.

In Aspect 5, the method of any of Aspects 1 to 4 includes where a first resolution level of the output lattice matches a second resolution level of the input lattice, and where the first resolution level of the output lattice is different from a third resolution level of the first LUT.

In Aspect 6, the method of any of Aspects 1 to 5 includes selecting a plurality of random input colors from an input color space based on a predetermined distribution, normalizing the plurality of random input colors to a predetermined range of values, computing a plurality of target colors by applying the normalized plurality of random input colors to a machine learning model, normalizing the plurality of target colors to the input color space, determining a reconstruction error based on the plurality of target colors, and adjusting weights of the machine learning model based on the reconstruction error to obtain the trained machine learning model.

In Aspect 7, the method of Aspect 6 includes where the predetermined distribution includes a uniform distribution of colors across the input color space.

In Aspect 8, the method of any of Aspects 6 or 7 includes determining occurrence probabilities of colors in the input color space, and determining the predetermined distribution based on the colors in the input color space having an occurrence probability that exceeds a predetermined threshold.

In Aspect 9, the method of any of Aspects 6 to 8 includes restricting the weights of the machine learning model through spectral normalization and activation functions. The output lattice includes an invertible approximation of the first LUT.

In Aspect 10, the method of any of Aspects 1 to 9 includes providing, to the trained machine learning model, a second identifier and the input lattice, the second identifier indicating the first LUT and a second LUT of the plurality of LUTs, and obtaining, from the trained machine learning model, another output lattice corresponding to a combination of the first LUT and the second LUT.

Aspect 11 is an apparatus for encoding LUTs. The apparatus includes a memory storing instructions, and one or more processors communicatively coupled to the memory. The one or more processors are configured to execute the instructions to perform one or more of the methods of any of Aspects 1 to 10.

Aspect 12 is an apparatus for encoding LUTs. The apparatus includes means for performing one or more of the methods of any of Aspects 1 to 10.

Aspect 13 is a non-transitory computer-readable storage medium storing computer-executable instructions for encoding LUTs by an apparatus. The computer-executable instructions are configured, when executed by one or more processors of the apparatus, to cause the apparatus to perform one or more of the methods of any of Aspects 1 to 10.

The foregoing disclosure provides illustration and description, but may not be intended to be exhaustive or to limit the implementations to the precise form disclosed. Modifications and variations are possible in light of the above disclosure or may be acquired from practice of the implementations.

For example, the terms “component,” “module,” “system” or the like are intended to include a computer-related entity, such as but not limited to hardware, firmware, a combination of hardware and software, software, or software in execution. For example, a component may be, but may not be limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations. Non-transitory computer-readable media may exclude transitory signals.

The computer readable storage medium may be a tangible device that may retain and store instructions for use by an instruction execution device. The computer readable storage medium may be, for example, but may not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EEPROM or Flash memory), a static random access memory (SRAM), a portable compact disc read-only memory (CD-ROM), a DVD, a memory stick, a floppy disk, a mechanically encoded device such as punch-cards or raised structures in a groove having instructions recorded thereon, and any suitable combination of the foregoing. A computer readable storage medium, for example, may not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local-area network (LAN) or a wide-area network (WAN), or the connection may be made to an external computer (for example, through the Internet using an internet service provider (ISP)). In some embodiments, electronic circuitry including, for example, programmable logic circuitry, field programmable gate arrays (FPGA), and/or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

At least one of the components, elements, modules or units (collectively “components” in this paragraph) represented by a block in the drawings (e.g., FIGS. 1 to 7) may be embodied as various numbers of hardware, software and/or firmware structures that execute respective functions described above, according to an example embodiment. According to example embodiments, at least one of these components may use a direct circuit structure, such as a memory, a processor, a logic circuit, a look-up table, or the like, that may execute the respective functions through controls of one or more microprocessors or other control apparatuses. Also, at least one of these components may be specifically embodied by a module, a program, or a part of code, which may contain one or more executable instructions for performing specified logic functions, and may be executed by one or more microprocessors or other control apparatuses. Further, at least one of these components may include or may be implemented by a processor such as a central processing unit (CPU) that may perform the respective functions, a microprocessor, or the like. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors. Furthermore, the components represented by a block or processing steps may employ any number of related art techniques for electronics configuration, signal processing and/or control, data processing or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The flowchart and block diagrams in the drawings illustrate the architecture, functionality, and operation of possible implementations of systems, methods, and computer readable media according to various embodiments. In this regard, each block in the flowchart or block diagrams may represent a module, segment, or portion of instructions, which includes one or more executable instructions for implementing the specified logical functions. The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

It may be apparent that systems and/or methods, described herein, may be implemented in different forms of hardware, firmware, or a combination of hardware and software. The actual specialized control hardware or software code used to implement these systems and/or methods may not be limiting of the implementations. Thus, the operation and behavior of the systems and/or methods were described herein without reference to specific software code—it being understood that software and hardware may be designed to implement the systems and/or methods based on the description herein.

No element, act, or instruction described in the present disclosure should be construed as critical or essential unless explicitly described as such. Also, for example, the articles “a” and “an” may be intended to include one or more items, and may be used interchangeably with “one or more.” Furthermore, for example, the term “set” may be intended to include one or more items (e.g., related items, unrelated items, a combination of related and unrelated items, or the like), and may be used interchangeably with “one or more.” Where only one item may be intended, the term “one” or similar language may be used. Also, for example, the terms “has,” “have,” “having,” “includes,” “including,” or the like may be intended to be open-ended terms. Further, the phrase “based on” may be intended to mean “based, at least in part, on” unless explicitly stated otherwise. In addition, expressions such as “at least one of [A] and [B]” or “at least one of [A] or [B]” may be understood to include only A, only B, or both A and B.

Reference throughout this specification to “one embodiment,” “an embodiment,” or similar language may indicate that a particular feature, structure, or characteristic described in connection with the indicated embodiment may be included in at least one embodiment of the present solution. Thus, the phrases “in one embodiment”, “in an embodiment,” and similar language throughout this specification may, but do not necessarily, all refer to the same embodiment. For example, such terms as “1st” and “2nd,” or “first” and “second” may be used to simply distinguish a corresponding component from another, and does not limit the components in other aspects (e.g., importance or order). It may be understood that if an element (e.g., a first element) may be referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It may be understood that when an element or layer may be referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element may be referred to as being “directly over,” “directly above,” “directly on,” “directly below,” “directly under,” “directly beneath,” “directly connected to” or “directly coupled to” another element or layer, there are no intervening elements or layers present.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations may be apparent to those of ordinary skill in the art without departing from the scope of the described embodiments. The terminology used herein may be chosen to best explain the principles of the embodiments, the practical application or technical improvement over technologies found in the marketplace, or to enable others of ordinary skill in the art to understand the embodiments disclosed herein.

It may be understood that the specific order or hierarchy of blocks in the processes/flowcharts disclosed are an illustration of exemplary approaches. Based upon design preferences, it may be understood that the specific order or hierarchy of blocks in the processes/flowcharts may be rearranged. Further, some blocks may be combined and/or omitted. The accompanying claims present elements of the various blocks in a sample order, and are not meant to be limited to the specific order or hierarchy presented.

Furthermore, the described features, advantages, and characteristics of the present disclosure may be combined in any suitable manner in one or more embodiments. One skilled in the relevant art may recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

What is claimed is:

1. A method for encoding color lookup tables (LUTs), comprising:
determining a first identifier corresponding to a first LUT of a plurality of LUTs, each LUT of the plurality of LUTs comprising mappings from input color values to output color values;
providing, to a trained machine learning model, the first identifier and an input lattice, the trained machine learning model having been jointly trained on the plurality of LUTs and identification information corresponding to each LUT in the plurality of LUTS;
obtaining, from the trained machine learning model, an output lattice corresponding to the first LUT; and
performing color manipulation on at least one input image using the output lattice.

2. The method of claim 1, wherein the input lattice comprises a regularly spaced grid,
wherein the output lattice comprises the first LUT, and
wherein the performing of the color manipulation on the at least one input image comprises applying the first LUT, obtained from the trained machine learning model, to the at least one input image.

3. The method of claim 1, wherein the input lattice comprises the at least one input image,
wherein the output lattice comprises at least one color-manipulated image based on the first LUT, the at least one color-manipulated image corresponding to the at least one input image, and
wherein the performing of the color manipulation on the at least one input image comprises providing the at least one color-manipulated image obtained from the trained machine learning model.

4. The method of claim 1, wherein the input lattice comprises a Hald image at a first resolution level, and
wherein the output lattice comprises the first LUT at the first resolution level.

5. The method of claim 1, wherein a first resolution level of the output lattice matches a second resolution level of the input lattice, and
wherein the first resolution level of the output lattice is different from a third resolution level of the first LUT.

6. The method of claim 1, further comprising:
selecting a plurality of random input colors from an input color space based on a predetermined distribution;
normalizing the plurality of random input colors to a predetermined range of values;
computing a plurality of target colors by applying the normalized plurality of random input colors to a machine learning model;
normalizing the plurality of target colors to the input color space;
determining a reconstruction error based on the plurality of target colors; and
adjusting weights of the machine learning model based on the reconstruction error to obtain the trained machine learning model.

7. The method of claim 6, wherein the predetermined distribution comprises a uniform distribution of colors across the input color space.

8. The method of claim 6, further comprising:
determining occurrence probabilities of colors in the input color space; and
determining the predetermined distribution based on the colors in the input color space having an occurrence probability that exceeds a predetermined threshold.

9. The method of claim 6, further comprising:
restricting the weights of the machine learning model through spectral normalization and activation functions,
wherein the output lattice comprises an invertible approximation of the first LUT.

10. The method of claim 1, further comprising:
providing, to the trained machine learning model, a second identifier and the input lattice, the second identifier indicating the first LUT and a second LUT of the plurality of LUTs; and
obtaining, from the trained machine learning model, another output lattice corresponding to a combination of the first LUT and the second LUT.

11. An apparatus for encoding color lookup tables (LUTs), comprising:
a memory storing instructions; and
one or more processors communicatively coupled to the memory; wherein the one or more processors are configured to execute the instructions to:
determine a first identifier corresponding to a first LUT of a plurality of LUTs, each LUT of the plurality of LUTs comprising mappings from input color values to output color values;
provide, to a trained machine learning model, the first identifier and an input lattice, the trained machine learning model having been jointly trained on the plurality of LUTs and identification information corresponding to each LUT in the plurality of LUTs;
obtain, from the trained machine learning model, an output lattice corresponding to the first LUT; and
perform color manipulation on at least one input image using the output lattice.

12. The apparatus of claim 11, wherein the input lattice comprises a regularly spaced grid,
wherein the output lattice comprises the first LUT, and
wherein the one or more processors are further configured to execute further instructions to:
apply the first LUT, obtained from the trained machine learning model, to the at least one input image.

13. The apparatus of claim 11, wherein the input lattice comprises the at least one input image,
wherein the output lattice comprises at least one color-manipulated image based on the first LUT, the at least one color-manipulated image corresponding to the at least one input image, and
wherein the one or more processors are further configured to execute further instructions to:
perform the color manipulation on the at least one input image using the at least one color-manipulated image obtained from the trained machine learning model.

14. The apparatus of claim 11, wherein the input lattice comprises a Hald image at a first resolution level, and
wherein the output lattice comprises the first LUT at the first resolution level.

15. The apparatus of claim 11, wherein a first resolution level of the output lattice matches a second resolution level of the input lattice, and
wherein the first resolution level of the output lattice is different from a third resolution level of the first LUT.

16. The apparatus of claim 11, wherein the one or more processors are further configured to execute further instructions to:
select a plurality of random input colors from an input color space based on a predetermined distribution;
normalize the plurality of random input colors to a predetermined range of values;
compute a plurality of target colors by applying the normalized plurality of random input colors to a machine learning model;
normalize the plurality of target colors to the input color space;
determine a reconstruction error based on the plurality of target colors; and
adjust weights of the machine learning model based on the reconstruction error to obtain the trained machine learning model,
wherein the predetermined distribution comprises a uniform distribution of colors across the input color space.

17. The apparatus of claim 16, wherein the one or more processors are further configured to execute further instructions to:
determine occurrence probabilities of colors in the input color space; and
determine the predetermined distribution based on the colors in the input color space having an occurrence probability that exceeds a predetermined threshold.

18. The apparatus of claim 16, wherein the one or more processors are further configured to execute further instructions to:
restrict the weights of the machine learning model through spectral normalization and activation functions,
wherein the output lattice comprises an invertible approximation of the first LUT.

19. A non-transitory computer-readable storage medium storing computer-executable instructions for encoding color lookup tables (LUTs) by an apparatus that, when executed by at least one processor of the apparatus, cause the apparatus to:
determine a first identifier corresponding to a first LUT of a plurality of LUTs, each LUT of the plurality of LUTs comprising mappings from input color values to output color values;
provide, to a trained machine learning model, the first identifier and an input lattice, the trained machine learning model having been jointly trained on the plurality of LUTs and identification information corresponding to each LUT in the plurality of LUTs;
obtain, from the trained machine learning model, an output lattice corresponding to the first LUT; and
perform color manipulation on at least one input image using the output lattice.

20. The non-transitory computer-readable storage medium of claim 19, wherein the computer-executable instructions, when executed by the at least one processor, further cause the apparatus to:
select a plurality of random input colors from an input color space based on a predetermined distribution;
normalize the plurality of random input colors to a predetermined range of values;
compute a plurality of target colors by applying the normalized plurality of random input colors to a machine learning model;
normalize the plurality of target colors to the input color space;
determine a reconstruction error based on the plurality of target colors; and
adjust weights of the machine learning model based on the reconstruction error to obtain the trained machine learning model.
